(19) United States
(12) Patent Application Publication
(10) Pub. No.: US 2006/0039145 A1
(43) Pub. Date: Feb. 23, 2006

(54) Ice cycle drops

(76) Inventors: Jared Hendricks, Draper, UT (US); Erik D. Bornemeier, Bountiful, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/185,164

(22) Filed: Jul. 20, 2005

Related U.S. Application Data
(60) Provisional application No. 60/600,713, filed on Jul. 20, 2004.

(51) Int. Cl. F21V 21/00

(52) U.S. Cl. 362/249; 362/391

(57) ABSTRACT

The present invention is a device for adapting a socket capable of receiving a light bulb into a socket also capable of receiving a light bulb and further comprising a strand with at least one dangling light extending therefrom. The dangling light strand electrically connects and receives power through the adaptor socket. In one exemplary embodiment, the adaptor device connects to a socket on a strand of holiday lights, and several evenly spaced dangling lights extend from the adaptor in a configuration sometimes referred to as icicle lights.

### RELATED APPLICATIONS

This application claims priority to U.S. Provisional Patent Application Ser. No. 60/600,713, filed on Jul. 20, 2004, and entitled “Ice Cycle Drops.”

### BACKGROUND OF THE INVENTION

1. Field of the Invention

The present invention relates to holiday or decorative lighting. In particular, the present invention is an adaptor device that connects to a socket on a strand of traditional holiday lighting. Attached to the adaptor device is a dangling strand of lights in a configuration sometimes referred to as icicle lights.

2. Background and Related Art

From the beginning of the 20^{th} century, people have strung lights in trees and on houses in celebration of Christmas. More recently, lighting strands have become a part of other holiday and celebratory occasions such as Halloween and weddings. As demand for holiday lighting arrangements has increased, lighting strand designs have become more varied in color, design, and size. As in many areas of decoration, traditional designs have given way to contemporary trends. Today, traditional lighting arrangements, consisting of evenly spaced and sized lights on a single strand, are being replaced by strands with more decorative appeal, such as icicle lights.

Thus, while techniques currently exist that provide traditional and contemporary holiday lighting arrangements, challenges still exist, including adapting traditional lighting designs to create new arrangements conforming to contemporary tastes. Furthermore, it is also desirable to have modular designs that provide arrangement flexibility.

Such devices are disclosed and claimed herein.

### SUMMARY OF THE INVENTION

The present invention relates to a lighting adaptor that converts a light socket into a socket with an attached strand of dangling lights. The converted light socket can be one of many on a strand of traditional holiday lighting.

In accordance with the invention as embodied and broadly described herein, the present invention features an electrical socket adaptor with an inserting end, capable of an electrical connection with a light socket, and a receiving end, capable of an electrical connection with a light bulb. In one embodiment, the socket is capable of both receiving a male end of a light bulb and inserting into a female light socket.

A dangling strand of lights, attached to the socket adaptor, receives power through an electrical connection to the socket adaptor. This electrical connection can be a series connection, a parallel connection, or a combination of both. Additionally, a fuse is located within the socket adaptor and electrically connects the socket adaptor with the dangling strand of lights.

The size, shape, type, color, quantity, spacing, and orientation of the light sockets and light bulbs on the dangling strand can be varied to accomplish a variety of lighting effects. In one embodiment, seven miniature white lights are spaced evenly along the dangling strand to create what is commonly known as an icicle lighting arrangement.

Furthermore, the size, shape, type, color, location and orientation of the socket adaptor can also be varied while keeping within the scope of this invention. One embodiment of the present invention uses an E12 sized socket for both the male and the female ends of the socket adaptor.

While the present invention is proven particularly useful in the area of holiday lighting, those skilled in the art can appreciate that the device can be used in a variety of different applications and in a variety of different areas of manufacture to yield modified lighting effects.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative lighting adaptor that converts a light socket into a socket with an attached strand of dangling lights.

FIG. 2 illustrates a representative lighting adaptor with a light bulb screwed into the female end of the adaptor.

FIG. 3 illustrates a circuit diagram for a parallel configuration of a lighting adaptor.

FIG. 4 illustrates a circuit diagram for a series configuration of a lighting adaptor.

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The presently preferred embodiments of the invention will be best understood by reference to the drawings wherein like parts are designated by like numerals throughout.

The present invention features a lighting adaptor that converts a light socket into a socket with an attached strand of dangling lights. In one application, the converted light socket is one of many on a strand of traditional holiday lighting.

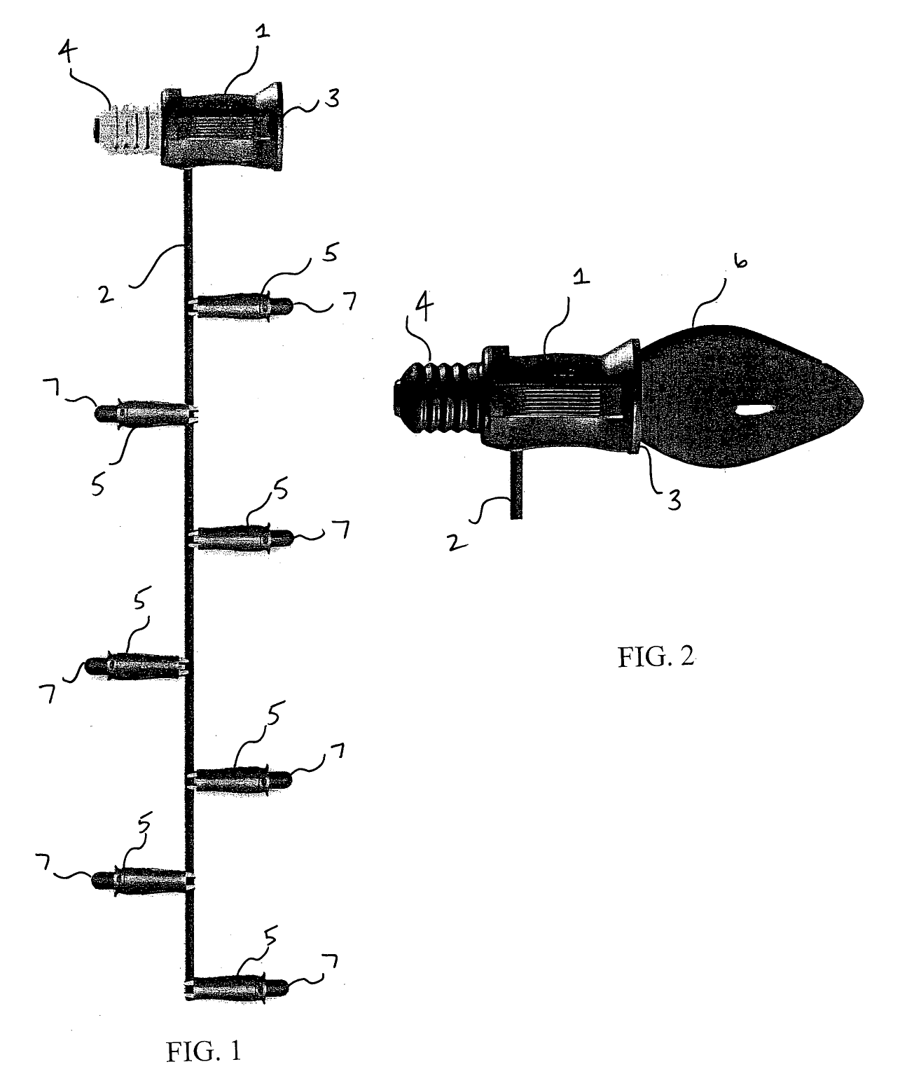

FIG. 1 illustrates a representative lighting adaptor that converts a light socket (not shown) into a socket 1 with an attached strand of dangling lights 2. The converted light socket (not shown) is any given socket capable of receiving a light bulb 6, such as a light socket on a string of holiday lighting. In an illustrative embodiment, the electrical socket adaptor 1 has an inserting end 4 capable of an electrical connection with a female end (not shown) and a receiving end 3 capable of an electrical connection with the male end of a light bulb 6 (as illustrated in FIG. 2). The specified orientation (male or female) of this illustrative adaptor does not limit the present invention; reversing the sex of the inserting end 4 and receiving end 3 of the socket adaptor 1 is well within the scope of the present invention. Additionally, the sizes of the inserting end 4 and receiving end 3, and socket type, may vary according to a desired lighting adaptation.

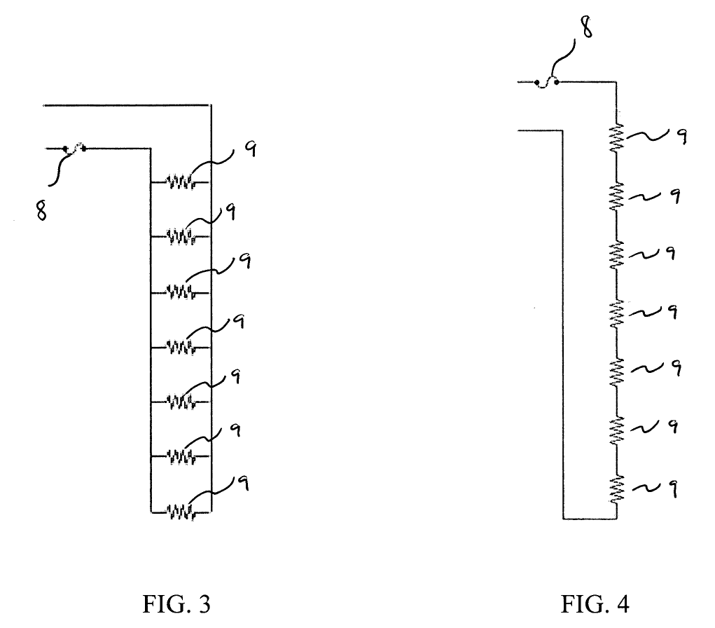

A dangling strand of lights 2 connects electrically to the socket adaptor 1. In one embodiment, a fuse 8, or other current limiting device, connects electrically between the socket adaptor 1 and the strand of dangling lights 2. At least one dangling light socket 5 connects electrically to the socket adaptor 1. This electrical connection can be a parallel connection (as illustrated in FIG. 4) or a series connection (as illustrated in FIG. 3), or a combination of both (not illustrated). One skilled in the art realizes that there are myriad combinations of electrical connections capable of electrically connecting the dangling light sockets 5 to the socket adaptor within the scope of the present invention. At least one dangling light bulb 7 is electrically connected to the at least one dangling light socket 5. The arrangement, number, size, and type of the dangling light sockets 5 on the strand of dangling lights 2 can vary depending on desired factors, such as lighting effect. In one embodiment, there are seven dangling light bulbs 6 connected to seven dangling light sockets 5 that are evenly spaced on a single strand of dangling lights 2.

FIG. 3 illustrates a circuit diagram for a parallel configuration of a lighting adaptor, and FIG. 4 illustrates a circuit diagram for a series configuration of a lighting adaptor. The resistors 9 represent dangling light bulbs 7 on the strand of dangling lights 2. The strand 2 connects electrically to the socket adaptor 1 in a way that provides power to illuminate the dangling light bulbs 7. As discussed above, the present invention is not limited to strictly a series or parallel electrical connection; a combination of both types of connection, or an equivalent thereof, may be implemented to accomplish the dangling light function.

Thus, as discussed herein, the embodiments of the present invention embrace a lighting adaptor that converts a light socket into a socket with an attached strand of dangling lights.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A device for adapting the appearance of a light socket, comprising:
an electrical socket adaptor with an inserting end, capable of an electrical connection with a light socket, and a receiving end, capable of an electrical connection with a light bulb; and
a dangling strand having at least one electrical socket, capable of receiving a light bulb, electrically connected to the socket adaptor in a way that provides electrical power to the at least one socket on the strand when electrical power is supplied to the socket adaptor.

2. The device of claim 1, further comprising:
a fuse positioned electrically between the socket adaptor and the dangling strand having at least one electrical socket.

3. A device for adapting the appearance of a light socket, comprising:
inserting means for connecting to the light socket;
receiving means for receiving a light bulb; and
dangling light means for connecting at least one dangling light bulb to the inserting means and receiving means.

4. A device for adapting the appearance of holiday lighting, comprising:
a lighting adaptor capable of both being electrically connected to a socket on a strand of holiday lighting and capable of receiving a light bulb; and
a dangling strand with at least one light socket electrically connected to the lighting adaptor in a way that provides electrical power to the at least one socket on the dangling strand when electrical power is supplied to the lighting adaptor.
